(19) United States
(12) Patent Application Publication
(10) Pub. No.: US 2007/0121906 A1
(43) Pub. Date: May 31, 2007

(54) Method and apparatus to detect off-hook state of parallel-connected telephone

(75) Inventor: Eog-kyu Kim, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/520,724

(22) Filed: Sep. 14, 2006

(30) Foreign Application Priority Data
Oct. 5, 2005 (KR) 2005-93328

(51) Int. Cl. H04M 1/00; H04M 3/00

(52) U.S. Cl. 379/350

(57) ABSTRACT

A method and apparatus to detect an off-hook state of a telephone connected in parallel to a communication terminal device connected to a telephone network. The method includes detecting a line voltage between both terminals of a line of the telephone network in an operation-ready state in which the communication terminal device is turned on, setting differently according to the line voltage an off-hook determination reference voltage to determine whether the parallel-connected telephone is off-hooked, and repeatedly detecting the line voltage between both terminals of the line and determining whether the parallel-connected telephone is off-hooked by comparing the repeatedly detected line voltage to the off-hook determination reference voltage.

### CROSS-REFERENCE TO RELATED APPLICATIONS

This application claims priority under 35 U.S.C. §119(a) from Korean Patent Application No.10-2005-0093328, filed on Oct. 5, 2005, in the Korean Intellectual Property Office, the disclosure of which is incorporated herein in its entirety by reference.

### BACKGROUND OF THE INVENTION

1. Field of the Invention

The present general inventive concept relates to a communication terminal device, and more particularly, to a method and apparatus to detect an off-hook state of a parallel-connected telephone by setting an off-hook determination reference voltage to a second off-hook determination reference voltage different from the off-hook determination reference voltage according to a line input voltage that varies according to an environmental condition of a communication terminal device.

2. Description of the Related Art

In general, a telephone is connected in parallel to a communication terminal device connected to a telephone network. The parallel-connected telephone is called a branch telephone. FIG. 1 illustrates a connection between a conventional communication terminal device 100 and a telephone 110. The general communication terminal device 100 and the telephone 110 are connected to a telephone line 120 in parallel.

Referring to FIG. 1, since a voltage between a tip 120a and a ring 120b of the telephone line 120 decreases compared to a normal voltage when the telephone 110 connected in parallel to the communication terminal device 100 is off-hooked, the communication terminal device 100 can inform a user whether the telephone 110 is busy by detecting the voltage between the tip 120a and the ring 120b and displaying a state of the telephone 110 on a display unit of the communication terminal device 100 according to the detected voltage.

FIG. 2 illustrates a voltage between both terminals of a telephone line when an off-hook state of a parallel-connected telephone is detected in the conventional communication terminal device of FIG. 1.

Referring to FIGS. 1 and 2, in a normal state where the parallel-connected telephone is not used (an idle mode), a line voltage of the telephone line 120 has a constant value of a first voltage V1. When the parallel-connected telephone is off-hooked, the line voltage decreases to a third voltage V3. Here, a second voltage V2 is a reference voltage for determining whether the parallel-connected telephone is off-hooked, and it is determined that the parallel-connected telephone is off-hooked if the line voltage decreases from the first voltage V1 to a voltage lower than the second voltage V2.

While the first voltage V1 of the communication terminal device connected to a general national switch network in the idle mode has a measured valued of 48V, the third voltage V3, when the parallel-connected telephone is off-hooked, is relatively and sufficiently low although the third voltage V3 varies according to a DC loop current value and a resistance value of the parallel-connected telephone. However, the first voltage V1 in private switch networks is usually set to a lower value than the first voltage V1 in a general switch network. In addition, in user environments different from each other, since a line having a small diameter is installed from a private switch network to a connection terminal to which the communication terminal device is connected, a voltage directly supplied to the communication terminal device is lower. Thus, when the first voltage V1 is low, a line voltage of the communication terminal device in the idle mode in which the parallel-connected telephone is not off-hooked is close to the second voltage V2 or becomes lower than the second voltage V2, and thereby the off-hook state of the parallel-connected telephone cannot be normally detected.

### SUMMARY OF THE INVENTION

The present general inventive concept provides a method and apparatus to detect an off-hook state of a parallel-connected telephone by setting an off-hook determination reference voltage differently according to a line voltage of a communication terminal device when a line voltage varies according to a user environment.

Additional aspects and advantages of the present general inventive concept will be set forth in part in the description which follows and, in part, will be obvious from the description, or may be learned by practice of the general inventive concept.

The foregoing and/or other aspect of the present inventive concept may be achieved by providing a method of detecting an off-hook state of a telephone connected in parallel to a communication terminal device connected to a telephone network, the method comprising detecting a line voltage between both terminals of a line of the telephone network in an operation-ready state in which the communication terminal device is turned on, setting differently according to the line voltage an off-hook determination reference voltage that is used to determine whether the parallel-connected telephone is off-hooked, and repeatedly detecting the line voltage between both terminals of the line and determining whether the parallel-connected telephone is off-hooked by comparing the repeatedly detected line voltage to the set off-hook determination reference voltage.

The setting of the off-hook determination reference voltage may comprise determining that the parallel-connected telephone cannot operate if the repeatedly detected line voltage is lower than a first threshold, and displaying an off-hook detection error according to the determination.

The setting of the off-hook determination reference voltage may comprise disabling the off-hook detection of the parallel-connected telephone if the repeatedly detected line voltage is equal to or higher than the first threshold and lower than a second threshold.

The setting of the off-hook determination reference voltage may comprise storing reference voltages corresponding to line voltages, and setting the off-hook determination reference voltage to one of the stored reference voltages according to the repeatedly detected line voltage.

The foregoing and/or other aspect of the present inventive concept may also be achieved by providing an apparatus to detect an off-hook state of a telephone connected in parallel to a communication terminal device connected to a telephone network, the apparatus comprising a line voltage recognition unit to recognize a line voltage detected between both terminals of a line of the telephone network in an operation-ready state in which the communication terminal device is turned on, a reference voltage setting unit to differently set an off-hook determination reference voltage to determine whether the parallel-connected telephone is off-hooked, according to the line voltage, and an off-hook determiner to determine whether the parallel-connected telephone is off-hooked by comparing the line voltage repeatedly detected between both terminals of the line to the set off-hook determination reference voltage.

The foregoing and/or other aspect of the present inventive concept may also be achieved by providing a computer readable recording medium containing computer readable codes to perform a method, the method comprising detecting a line voltage between both terminals of a line of a telephone network in an operation-ready state in which a communication terminal device is turned on, setting differently according to the line voltage an off-hook determination reference voltage that is used to determine whether the parallel-connected telephone is off-hooked, and repeatedly detecting the detected line voltage between both terminals of the line and determining whether the parallel-connected telephone is off-hooked by comparing the repeatedly detected line voltage to the off-hook determination reference voltage.

The foregoing and/or other aspect of the present inventive concept may also be achieved by providing a communication terminal device connected to a telephone network with a telephone, the communication terminal device comprising a terminal connected to an external telephone network, and a controller to receive a line voltage from the terminal, and to generate an off-hook determination reference voltage according to an initial value of the line voltage such that the controller determines a state of the telephone according to the line voltage and the generated off-hook determination reference voltage.

The foregoing and/or other aspect of the present inventive concept may also be achieved by providing a communication terminal device connected to a telephone network with a telephone in parallel, the communication terminal device comprising a terminal to be connected to an external telephone network having an external telephone connected thereto in parallel, and a controller to receive a first line voltage from the terminal, to generate an off-hook determination reference voltage according to the first line voltage, to receive a second line voltage after the generation of the off-hook determination reference voltage, and determines a state of the telephone according to the second line voltage and the generated off-hook determination reference voltage.

The foregoing and/or other aspect of the present inventive concept may also be achieved by providing a method of a communication terminal device connected to an external telephone network with an external telephone connected thereto in parallel, the method comprising receiving a first line voltage from the terminal, generating an off-hook determination reference voltage according to the first line voltage, receiving a second line voltage after the generation of the off-hook determination reference voltage, and determining a state of the telephone according to the second line voltage and the generated off-hook determination reference voltage.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a connection between a conventional communication terminal device and a telephone connected to a telephone line in parallel;

FIG. 2 illustrates a voltage between both terminals of a line when an off-hook state of a parallel-connected telephone is detected in the conventional communication terminal device;

FIG. 3 is a block diagram illustrating a communication terminal device according to an embodiment of the present general inventive concept;

FIG. 4 is a block diagram illustrating an apparatus to detect an off-hook state of a parallel-connected telephone according to an embodiment of the present general inventive concept;

FIG. 5 is a flowchart illustrating a method of detecting an off-hook state of a parallel-connected telephone according to an embodiment of the present general inventive concept; and

FIG. 6 illustrates an off-hook determination reference voltage differently set according to line voltages detected when a parallel-connected telephone is off-hooked, according to an embodiment of the present general inventive concept.

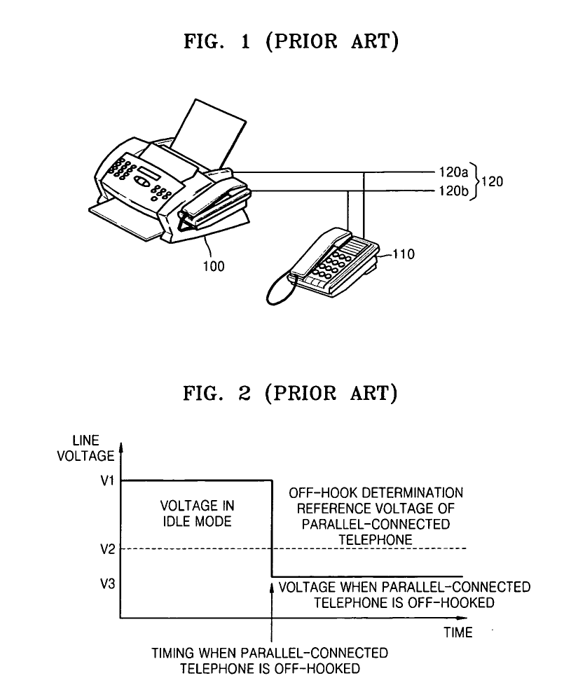

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

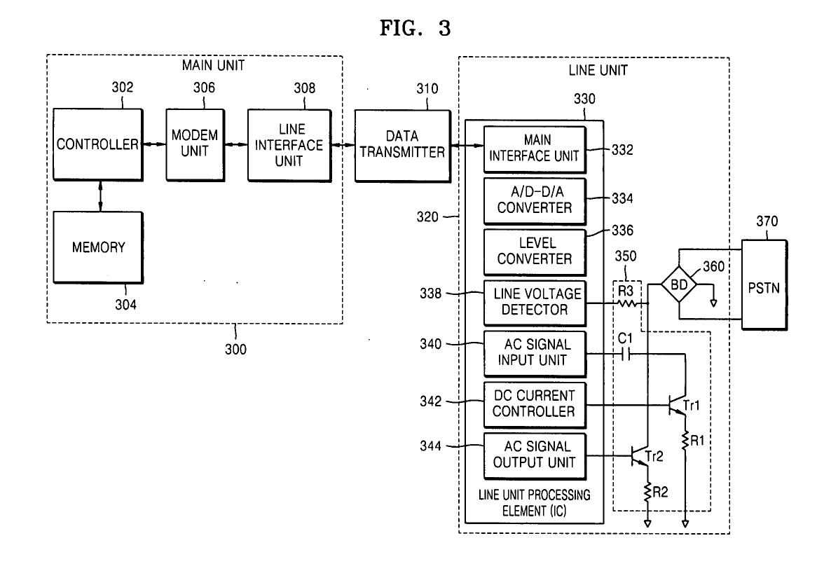

FIG. 3 is a block diagram illustrating a communication terminal device according to an embodiment of the present general inventive concept.

Referring to FIG. 3, the communication terminal device, such as a facsimile device, is connected to a telephone network (or a telephone line) and includes a main unit 300, a data transmitter 310, a line unit 320, and a public switched telephone network (PSTN) 370 as the telephone network. It is possible that a telephone is connected to the PSTN 370 in parallel with the communication terminal device.

According to the present embodiment, the main unit 300 includes a controller 302, a memory 304, a modem unit 306, and a line interface unit 308.

The line unit 320 includes a line unit processing element 330, i.e., an integrated circuit, which includes a main interface unit 332, an analog/digital-digital/analog (A/D-D/A) converter 334, a level converter 336, a line voltage detector 338, an AC signal input unit 340, a DC current controller 342, and an AC signal output unit 344, a PSTN connection unit 350, and a bridge diode unit 360.

In the communication terminal device illustrated in FIG. 3, due to the bridge diode unit 360, a positive voltage is always supplied to transistors Tr1 and Tr2 even if a polarity of a switch connected to the PSTN connection unit 350 is changed. The DC current controller 342 of the line unit processing element 330, the transistor Tr1, and a resistor R1 allow a constant current to flow to the PSTN 370. The AC signal output unit 344, the transistor Tr2, and a resistor R2 amplify an output AC signal and send the amplified output AC signal to the PSTN 370. A capacitor C1 removes a DC component from an input AC signal input from the PSTN 370 and transfers the input AC signal without the DC component to the AC signal input unit 340.

The line unit processing element 330 inter-operating with the PSTN connection unit 350 including the transistors Tr1 and Tr2, the resistors R1, R2, and R3, and the capacitor C1 described above is commonly called a data access arrangement (DAA) element.

The data transmitter 310 is located between the main unit 300 and the line unit 320 and transfers a predetermined data signal, a clock signal, etc.

The main unit 300 processes a fax signal and a voice signal. The modem unit 306 is connected to the data transmitter 310 through the line interface unit 308 and transmits/receives the fax signal and the voice signal.

When the fax signal is transmitted and/or received, an output signal generated by the modem unit 306 is converted to a predetermined digital data by the line interface unit 308 and transmitted to the main interface unit 332 of the line unit processing element 330 through the data transmitter 310. The digital data is converted to an AC signal by the A/D-D/A converter 334 of the line unit processing element 330 and the converted AC signal is output to a base of the transistor Tr2 by the AC signal output unit 344. The transistor Tr2 includes two terminals connected to the BD 360 and a potential through the resistor R2. The transistor Tr2 amplifies the converted AC signal input through its base and sends the amplified AC signal to the PSTN 370.

The line voltage detector 338 of the line unit processing element 330 detects a line voltage (or analog signal) between both terminals (a tip and a ring) of a line, which is input through the resistor R3, and converts the detected analog signal to a digital signal. The digital signal of the detected line voltage is input to the main unit 300 through the data transmitter 310.

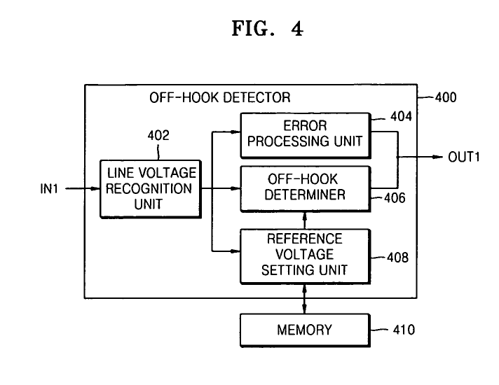

FIG. 4 is a block diagram illustrating an apparatus to detect an off-hook state of a parallel-connected telephone according to an embodiment of the present general inventive concept.

Referring to FIGS. 3 and 4, the off-hook detection apparatus includes an off-hook detector 400 and may include a memory 410. That is, the off-hook detector 400 is an internal component of the controller 302 of the communication terminal device of FIG. 3, and the memory 410 can be an internal component of the controller 302 of the communication terminal device. In this case, the off-hook detector 400 and the memory 410 are constructed in a single chip. It is possible that the memory 410 can be a different component separate from the controller 302.

The off-hook detector 400 includes a line voltage recognition unit 402, an error processing unit 404, an off-hook determiner 406, and a reference voltage setting unit 408.

An input signal IN1 indicating a value of the line voltage value is detected by the line voltage detector 338 of FIG. 3 and input to the line voltage recognition unit 402 by passing through the data transmitter 310, the line interface unit 308, and the modem unit 306.

The line voltage recognition unit 402 recognizes the line voltage of the communication terminal device from the input signal IN1.

The line voltage recognition unit 402 determines that the parallel-connected telephone cannot operate if the line voltage is lower than a first threshold. The line voltage is lower than the first threshold when the parallel-connected telephone cannot operate due to a malfunction of the parallel-connected telephone or a defect of the line.

When the line voltage recognition unit 402 determines that the parallel-connected telephone cannot operate, the error processing unit 404 informs a user of an off-hook detection error. The off-hook detection error can be variously displayed according to a display unit (not shown) installed in the communication terminal device. For example, to display the off-hook detection error, a light emitted diode (LED) can flicker, or characters can be displayed on a liquid crystal display (LCD). It is possible that a message indicating the off-hook detection error can be printed using a printer, or if the communication terminal device is connected to a host personal computer (PC), a message indicating the off-hook detection error can be displayed on a monitor of the host PC.

If the recognized line voltage is equal to or higher than the first threshold and lower than a second threshold, the voltage recognition unit 402 disables the off-hook detection of the off-hook determiner 406. When the recognized line voltage is equal to or higher than the first threshold and lower than the second threshold, since an operation of the parallel-connected telephone may be unstable according to a circuit characteristic, i.e., a DC resistance value, of the parallel-connected telephone, the off-hook determiner 406 cannot correctly determine whether the parallel-connected telephone is off-hooked.

The reference voltage setting unit 408 sets differently according to the line voltage an off-hook determination reference voltage that is used to determine whether the parallel-connected telephone is off-hooked. That is, the reference voltage setting unit 408 sets the off-hook determination reference voltage to a second off-hook determination reference voltage to replace the off-hook determination reference voltage such that the second off-hook determination reference voltage is used to determine whether the parallel-connected telephone is off-hooked. The memory 410 stores reference voltages corresponding to various line voltages, and the reference voltage setting unit 408 sets the off-hook determination reference voltage to a reference voltage stored in the memory 410 according to a detected line voltage.

Table 1 illustrates reference voltages according to line voltages.

TABLE 1

| Line voltage | Reference voltage |
|---|---|
| higher than 30 V | 25 V |
| 25˜30 V | 20 V |
| 20˜25 V | 18 V |
| 18˜20 V | 16 V |
| 15˜18 V | Parallel-connected telephone does not recognize |
| Lower than 18 V | Error processing |

Here, 15 V correspond to the first threshold, and 18 V correspond to the second threshold, for example.

The off-hook determiner 406 determines whether the parallel-connected telephone is off-hooked by comparing the off-hook determination reference voltage set by the reference voltage setting unit 408 to a line voltage periodically or repeatedly detected between both terminals of the line.

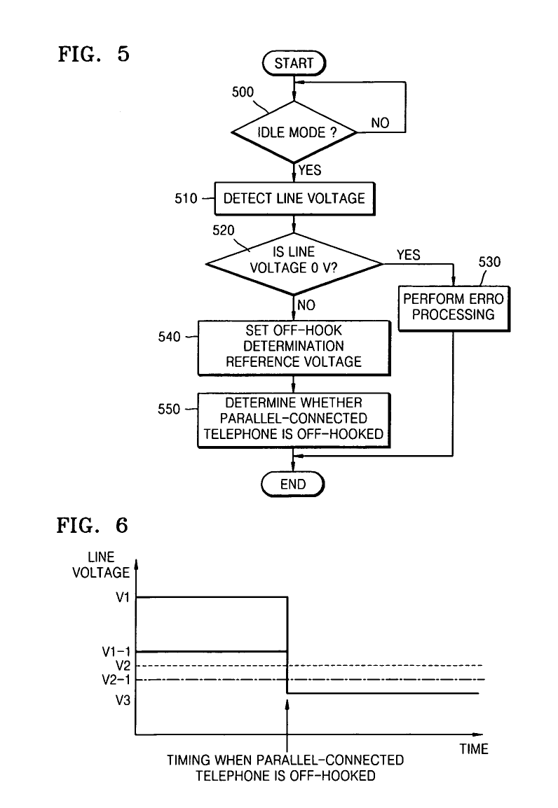

FIG. 5 is a flowchart illustrating a method of detecting an off-hook state of a parallel-connected telephone according to an embodiment of the present general inventive concept.

Referring to FIG. 5, in operation 500, it is determined whether a communication terminal device is in an operation-ready state after the communication terminal device is turned on, i.e., in an idle mode. If the communication terminal device is in the idle mode, a line voltage between both terminals of a line of a PSTN is detected in operation 510.

In operation 520, it is determined whether the detected line voltage is 0 V. If the detected line voltage is 0 V, an off-hook detection error is displayed in operation 530. For example, a line voltage is 0 V when the PSTN is connected to a line code thereof. The display of the off-hook detection error can be performed in various ways as described above.

If the detected line voltage is not 0 V, an off-hook determination reference voltage for determining whether the parallel-connected telephone is off-hooked is differently set according to a line voltage in operation 540. If the detected line voltage is lower than a first threshold, an off-hook detection error can be displayed by determining that the parallel-connected telephone cannot operate. If the detected line voltage is equal to or higher than the first threshold and lower than a second threshold, the off-hook detection of the parallel-connected telephone can be disabled.

FIG. 6 illustrates off-hook determination reference voltages differently set according to line voltages in operation 540. When the line voltage is a first voltage V1, the off-hook determination reference voltage is set to a second voltage V2, and when the line voltage is a first sub voltage V1-1 lower than the first voltage V1, the off-hook determination reference voltage is set to a second sub voltage V2-1 lower than the second voltage V2 and higher than a third voltage as illustrated in FIG. 6.

In operation 550, the line voltage between both terminals of the line is periodically or repeatedly detected, and it is determined whether the parallel-connected telephone is off-hooked by comparing the repeatedly detected line voltage to the off-hook determination reference voltage.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As described above, according to embodiments of the present general inventive concept, even if a line voltage varies according to a user environment, the off-hook detection of a parallel-connected telephone can be correctly performed by differently setting an off-hook determination reference voltage according to a line voltage of a communication terminal device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of detecting an off-hook state of a telephone connected to a telephone network in parallel with a communication terminal device, the method comprising:
detecting a line voltage between both terminals of a line of the telephone network in an operation-ready state in which the communication terminal device is turned on;
setting differently according to the line voltage an off-hook determination reference voltage that is used to determine whether the parallel-connected telephone is off-hooked; and
repeatedly detecting the detected line voltage between both terminals of the line and determining whether the parallel-connected telephone is off-hooked by comparing the repeatedly detected line voltage to the off-hook determination reference voltage.

2. The method of claim 1, wherein the setting of the off-hook determination reference voltage comprises:
determining that the parallel-connected telephone cannot operate if the repeatedly detected line voltage is lower than a first threshold; and
displaying an off-hook detection error according to the determination.

3. The method of claim 1, wherein the setting of the off-hook determination reference voltage comprises disabling an off-hook detection operation of the parallel-connected telephone if the repeatedly detected line voltage is equal to or higher than a first threshold and lower than a second threshold.

4. The method of claim 1, wherein the setting of the off-hook determination reference voltage comprises:
storing reference voltages corresponding to line voltages; and
setting the off-hook determination reference voltage to one of the stored reference voltages according to the repeatedly detected line voltage.

5. An apparatus to detect an off-hook state of a telephone connected to a telephone network in parallel with a communication terminal device, the apparatus comprising:
a line voltage recognition unit to recognize a line voltage detected between both terminals of a line of the telephone network in an operation-ready state in which the communication terminal device is turned on;
a reference voltage setting unit to set differently according to the line voltage an off-hook determination reference voltage for determining whether the parallel-connected telephone is off-hooked; and
an off-hook determiner to determine whether the parallel-connected telephone is off-hooked by comparing the line voltage repeatedly detected between both terminals of the line to the off-hook determination reference voltage.

6. The apparatus of claim 5, further comprising:
an error processing unit to generate an off-hook detection error signal to be displayed when the line voltage recognition unit determines that the parallel-connected telephone does not operate if the repeatedly detected line voltage is lower than a first threshold.

7. The apparatus of claim 5, wherein the line voltage recognition unit disables an off-hook detection operation of the parallel-connected telephone if the repeatedly detected line voltage is equal to or higher than a first threshold and lower than a second threshold.

8. The apparatus of claim 5, further comprising:
a memory to store reference voltages corresponding to plurality of values of the line voltage,
wherein the reference voltage setting unit sets the off-hook determination reference voltage to one of the reference voltages stored in the memory according to the repeatedly detected line voltage.

9. A computer readable recording medium containing computer readable codes to perform a method, the method comprising:
detecting a line voltage between both terminals of a line of a telephone network in an operation-ready state in which a communication terminal device is turned on;
setting differently according to the line voltage an off-hook determination reference voltage that is used to determine whether the parallel-connected telephone is off-hooked; and
repeatedly detecting the detected line voltage between both terminals of the line and determining whether the parallel-connected telephone is off-hooked by comparing the repeatedly detected line voltage to the off-hook determination reference voltage.

10. A communication terminal device connected to a telephone network with a telephone, the communication terminal device comprising:
a terminal to be connected to an external telephone network having an external telephone connected thereto in parallel; and
a controller to receive a line voltage from the terminal, and to generate an off-hook determination reference voltage according to an initial value of the line voltage such that the controller determines a state of the telephone according to the line voltage and the generated off-hook determination reference voltage.

11. The device of claim 10, wherein the controller receives the initial value of the line voltage when the communication terminal device is turned on.

12. The device of claim 11, wherein the controller generates the off-hook determination reference voltage varying according to the initial value of the line voltage and a detection of a turn-on state of the communication terminal device.

13. The device of claim 11, wherein the controller detects the initial value of the line voltage according to a detection of a turn-on state of the communication terminal device.

14. The device of claim 11, wherein the controller uses the off-hook determination reference voltage to determine the state of the telephone until the communication terminal device is changed from a turn-on state to a turn-off state.

15. The device of claim 11, wherein the controller receives a second line voltage through the terminal after a detection of a turn-on-state of the communication terminal device and determines the state of the telephone according to the second line voltage and the generated off-hook determination reference voltage.

16. The device of claim 11, wherein the controller detects the initial value of the line voltage according to a detection of a turn-on state thereof, receives a second line voltage through the terminal after generation of the off-hook determination reference voltage, and determines the state of the telephone according to the second line voltage and the generated off-hook determination reference voltage

17. The device of claim 11, wherein the controller generates a second off-hook determination reference voltage to determine the state of the telephone according to the initial value of the line voltage when the communication terminal device is turned on.

18. The device of claim 11, wherein the state of the telephone comprises an off-hook state of the telephone.

19. The device of claim 11, wherein the controller receives or sends a fax signal through the terminal according to the off-hook determination reference voltage.

20. The device of claim 11, further comprising:
a main unit including the controller to generate a fax signal;
a data transmitter to transmit the generated fax signal; and
a line unit disposed between the data transmitter and the terminal to transmit the fax signal to the telephone network.

21. The device of claim 11, wherein the controller stores a predetermined off-hook determination reference voltage and changes the predetermined off-hook determination reference voltage to the generated off-hook determination reference voltage.

22. The device of claim 11, wherein the initial value of the line voltage comprises one of a first initial value and a second initial value, and the controller generates one of a first off-hook determination reference voltage and a second off-hook determination reference voltage as the off-hook determination reference voltage according to the one of the first initial value and the second initial value.

23. A communication terminal device connected to a telephone network with a telephone in parallel, the communication terminal device comprising:
a terminal to be connected to an external telephone network having an external telephone connected thereto in parallel; and
a controller to receive a first line voltage from the terminal, to generate an off-hook determination reference voltage according to the first line voltage, to receive a second line voltage after the generation of the off-hook determination reference voltage, and determines a state of the telephone according to the second line voltage and the generated off-hook determination reference voltage.

24. A method of a communication terminal device connected to an external telephone network with an external telephone connected thereto in parallel, the method comprising:
receiving a first line voltage from the terminal;
generating an off-hook determination reference voltage according to the first line voltage;
receiving a second line voltage after the generation of the off-hook determination reference voltage; and
determining a state of the telephone according to the second line voltage and the generated off-hook determination reference voltage.
